(19) United States
(12) Patent Application Publication
(10) Pub. No.: US 2019/0297593 A1
(43) Pub. Date: Sep. 26, 2019

(54) APPARATUSES AND METHODS FOR HANDLING 5G SYSTEM (5GS) LOCATION INFORMATION

(71) Applicant: MediaTek Singapore Pte. Ltd., Singapore (SG)

(72) Inventors: Marko Niemi, Oulu (FI); Jaakko Sitomaniemi, Oulu (FI); Matti Moisanen, Oulu (FI)

(21) Appl. No.: 16/359,047

(22) Filed: Mar. 20, 2019

Related U.S. Application Data
(60) Provisional application No. 62/645,879, filed on Mar. 21, 2018.

(51) Int. Cl. H04W 64/00; H04W 8/02; H04W 48/04

(52) U.S. Cl. CPC H04W 64/00; H04W 48/04; H04W 8/02

(57) ABSTRACT

A User Equipment (UE) including a wireless transceiver, a storage device, and a controller is provided. The wireless transceiver performs wireless transmission and reception to and from a 5G network. The storage device includes a data space specific for 5G System (5GS) location information. The controller obtains the 5GS location information by communicating with the 5G network via the wireless transceiver, and stores the 5GS location information in the data space of the storage device.

### CROSS REFERENCE TO RELATED APPLICATIONS

This application claims priority of U.S. Provisional Application No. 62/645,879, filed on Mar. 21, 2018, the entirety of which is incorporated by reference herein.

### BACKGROUND OF THE APPLICATION

### Field of the Application

The application generally relates to location information handling, and more particularly, to apparatuses and methods for handling 5G System (5GS) location information.

### Description of the Related Art

In a typical mobile communication environment, a User Equipment (UE) (also called Mobile Station (MS)), such as a mobile telephone (also known as a cellular or cell phone), or a tablet Personal Computer (PC) with wireless communications capability, may communicate voice and/or data signals with one or more service networks. The wireless communications between the UE and the service networks may be performed using various Radio Access Technologies (RATs), such as Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, LTE-Advanced (LTE-A) technology, etc.

These wireless technologies have been adopted for use in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the Third Generation Partnership Project (3GPP). It is designed to better support mobile broadband Internet access by improving spectral efficiency, reducing costs, and improving services.

However, due to the specifications for 5G NR still being under discussion among 3GPP members, many details are not yet identified, including which 5G specific information should or should not be stored by a User Equipment (UE).

### BRIEF SUMMARY OF THE APPLICATION

The present application proposes that a UE should store the 5GS location information in a storage device, such as a Universal Subscriber Identity Module (USIM) or a non-volatile memory, wherein the 5GS location information at least includes separate 5G Globally Unique Temporary Identifiers (GUTIs) for 3GPP access and non-3GPP access, separate last visited registered Tracking Area Identities (TAIs) for 3GPP access and non-3GPP access, and separate 5GS update statuses for 3GPP access and non-3GPP access.

In one aspect of the application, a User Equipment (UE) comprising a wireless transceiver, a storage device, and a controller is provided. The wireless transceiver is configured to perform wireless transmission and reception to and from a 5G network. The storage device comprises a data space specific for 5G System (5GS) location information. The controller is configured to obtain the 5GS location information by communicating with the 5G network via the wireless transceiver, and store the 5GS location information in the data space of the storage device.

In another aspect of the application, a method for handling 5GS location information, executed by a UE communicatively connected to a 5G network, is provided. The method comprises the steps of: enabling a storage device in the UE, which comprises a data space specific for 5GS location information; obtaining the 5GS location information by communicating with the 5G network; and storing the 5GS location information in the data space of the storage device.

Other aspects and features of the present application will become apparent to those with ordinarily skill in the art upon review of the following descriptions of specific embodiments of the UEs and the methods for handling 5GS location information.

### BRIEF DESCRIPTION OF DRAWINGS

The application can be more fully understood by reading the subsequent detailed description and examples with references made to the accompanying drawings, wherein:

FIG. 1 is a block diagram of a wireless communication environment according to an embodiment of the application;

FIG. 2 is a block diagram illustrating the UE 110 according to an embodiment of the application; and

FIG. 3 is a flow chart illustrating the method for handling 5GS location information according to an embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

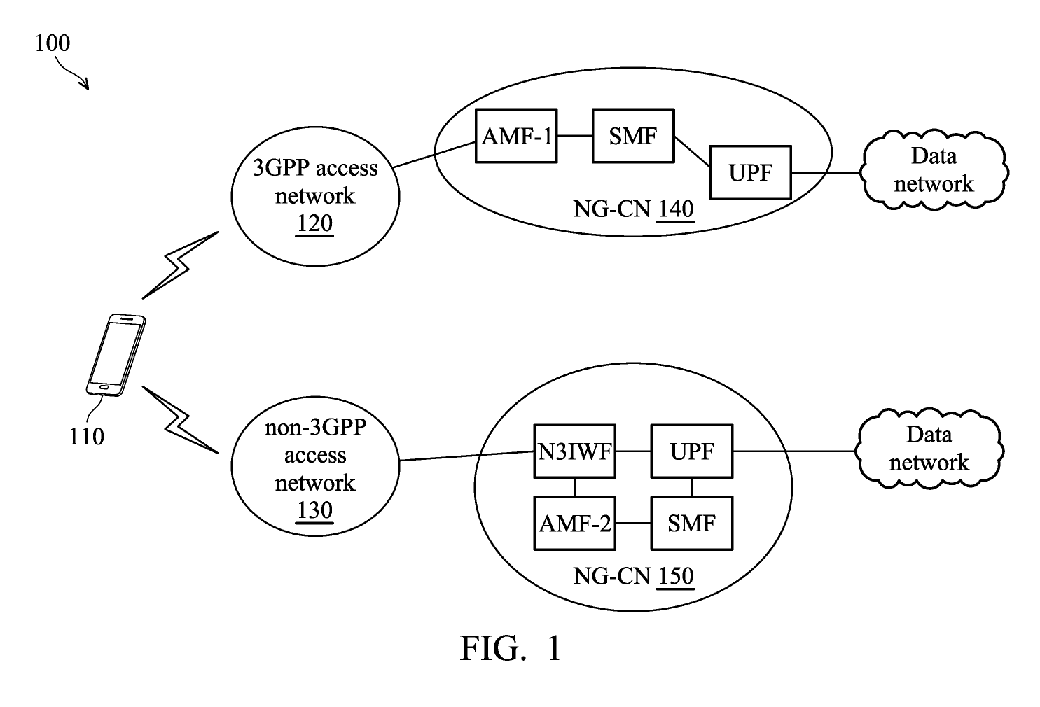

FIG. 1 is a block diagram of a wireless communication environment according to an embodiment of the application.

The wireless communication environment 100 includes a UE 110, a 3GPP access network 120, a non-3GPP access network 130, and two Next Generation Core Network (NG-CNs) 140 and 150.

The UE 110 may be a feature phone, a smartphone, a tablet PC, a laptop computer, or any wireless communication device supporting the RATs utilized by the 3GPP access network 120, the non-3GPP access network 130, and the NR-CNs 140 and 150.

The UE 110 may be wirelessly connected to one or both of the NR-CN 140 via the 3GPP access network 120 and the NR-CN 150 via the non-3GPP access network 130. For example, the UE 110 may communicate with the NR-CN 140 via the 3GPP access network 120 and/or the NR-CN 150 via the non-3GPP access network 130, to obtain 5GS location information, including 5GS location information for 3GPP access, and/or 5GS location information for non-3GPP access, and locally store the 5GS location information per access.

The 3GPP access network 120 is an access network utilizing one of the RATs specified by 3GPP. For example, the 3GPP access network 120 may be a GSM EDGE Radio Access Network (GERAN), Universal Terrestrial Radio Access Network (UTRAN), Evolved UTRAN (E-UTRAN), or Next Generation Radio Access Network (NG-RAN).

For example, if the 3GPP access network 120 is an E-UTRAN, it may include at least one evolved NodeB (eNB) (e.g., macro eNB, femto eNB, or pico eNB).

If the 3GPP access network 120 is an NG-RAN, it may include one or more cellular stations, such as gNBs, which support high frequency bands (e.g., above 24 GHz), and each gNB may further include one or more Transmission Reception Points (TRPs), wherein each gNB or TRP may be referred to as a 5G cellular station. Some gNB functions may be distributed across different TRPs, while others may be centralized, leaving the flexibility and scope of specific deployments to fulfill the requirements for specific cases.

The non-3GPP access network 130 is an access network utilizing one RAT not specified by 3GPP. For example, the non-3GPP access network 130 may be a Wireless-Fidelity (Wi-Fi) network, a WiMAX network, a CDMA network, or a fixed network (e.g., a Digital Subscriber Line (DSL) network).

The 3GPP access network 120 is responsible for processing radio signals, terminating radio protocols, and connecting the UE 110 with the NG-CN 140, while the NG-CN 140 is responsible for performing mobility management, network-side authentication, and interfaces with a public/external data network (e.g., the Internet). Likewise, the non-3GPP access network 130 is responsible for processing radio signals, terminating radio protocols, and connecting the UE 110 with the NG-CN 150, while the NG-CN 150 is responsible for performing mobility management, network-side authentication, and interfaces with a public/external data network (e.g., the Internet).

The NR-CNs 140 and 150 may be located in the same Public Land Mobile Network (PLMN) or in different PLMNs. Each of the NG-CN 140 and the NG-CN 150 may support various network functions, including an AMF, a Session Management Function (SMF), a User Plane Function (UPF), a Policy Control Function (PCF), an Application Function (AF), and an Authentication Server Function (AUSF), wherein each network function may be implemented as a network element on a dedicated hardware, or as a software instance running on a dedicated hardware, or as a virtualized function instantiated on an appropriate platform, e.g., a cloud infrastructure.

The AMF provides UE-based authentication, authorization, mobility management, etc. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functions per session. The AF provides information on the packet flow to PCF responsible for policy control in order to support Quality of Service (QoS). Based on the information, the PCF determines policies about mobility and session management to make the AMF and the SMF operate properly. The AUSF stores data for authentication of UEs, while the UDM stores subscription data of UEs.

Specifically, the NG-CN 140 may include at least an AMF (denoted as AMF-1), a SMF, and a UPF, while the NG-CN 150 may include at least a Non-3GPP Inter-Working Function (N3IWF), an AMF (denoted as AMF-2), a SMF, and a UPF. The N3IWF may enable the UE 110 to attach to the NG-CN 150 either via trusted non-3GPP access or via untrusted non-3GPP access.

It should be understood that the 5G system depicted in FIG. 1 is for illustrative purposes only and is not intended to limit the scope of the application. For example, the UE 110 may only connect to either the NR-CN 140 via the 3GPP access network 120 or the NR-CN 150 via the non-3GPP access network 130.

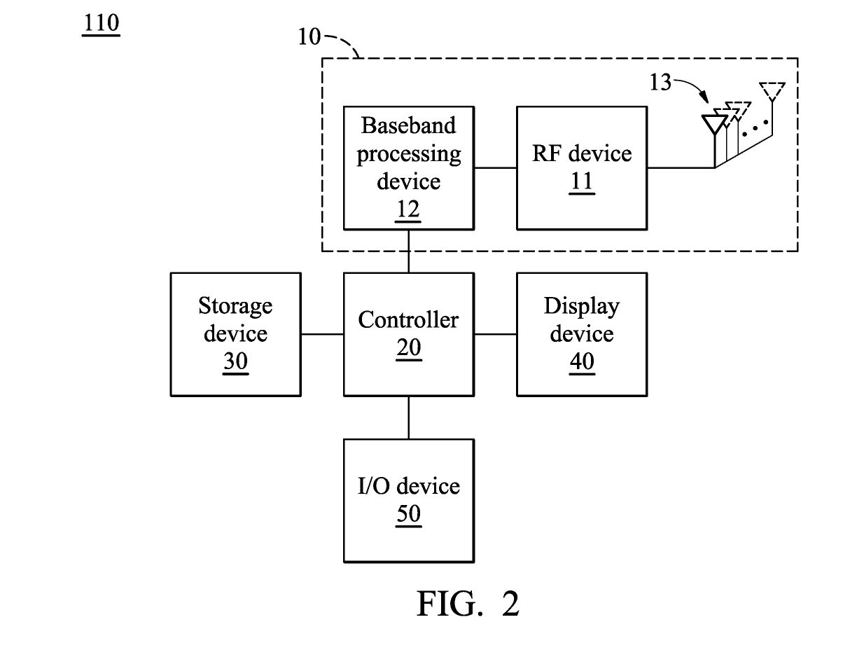

FIG. 2 is a block diagram illustrating the UE 110 according to an embodiment of the application.

The UE 110 includes a wireless transceiver 10, a controller 20, a storage device 30, a display device 40, and an Input/Output (I/O) device 50.

The wireless transceiver 10 is configured to perform wireless transmission and reception to and from the 3GPP access network 120 and/or the non-3GPP access network 130. Specifically, the wireless transceiver 10 includes a Radio Frequency (RF) device 11, a baseband processing device 12, and antenna(s) 13, wherein the antenna(s) 13 may include one or more antennas for beamforming. The baseband processing device 12 is configured to perform baseband signal processing and control the communications between subscriber identity card(s) (not shown) and the RF device 11. The baseband processing device 12 may contain multiple hardware components to perform the baseband signal processing, including Analog-to-Digital Conversion (ADC)/Digital-to-Analog Conversion (DAC), gain adjusting, modulation/demodulation, encoding/decoding, and so on. The RF device 11 may receive RF wireless signals via the antenna(s) 13, convert the received RF wireless signals to baseband signals, which are processed by the baseband processing device 12, or receive baseband signals from the baseband processing device 12 and convert the received baseband signals to RF wireless signals, which are later transmitted via the antenna(s) 13. The RF device 11 may also contain multiple hardware devices to perform radio frequency conversion. For example, the RF device 11 may include a mixer to multiply the baseband signals with a carrier oscillated in the radio frequency of the supported cellular technologies, wherein the radio frequency may be 900 MHz, 1900 MHz or 2100 MHz utilized in 3G (e.g., WCDMA) systems, or 900 MHz, 2100 MHz, or 2.6 GHz utilized in 4G (e.g., LTE) systems, or any radio frequency (e.g., 30 GHz-300 GHz for mmWave) utilized in 5G (e.g., NR) systems, or another radio frequency, depending on the RAT in use.

The controller 20 may be a general-purpose processor, a Micro Control Unit (MCU), an application processor, a Digital Signal Processor (DSP), or the like, which includes various circuits for providing the functions of data processing and computing, controlling the wireless transceiver 10 for wireless transmission and reception to and from the 3GPP access network 120 and/or the non-3GPP access network 130, enabling the storage device 30 and storing and retrieving data (e.g., 5G location information) to and from the storage device 30, sending a series of frame data (e.g. representing text messages, graphics, images, etc.) to the display device 40, and receiving/outputting signals from/to the I/O device 50.

In particular, the controller 20 coordinates the aforementioned operations of the wireless transceiver 10, the storage device 30, the display device 40, and the I/O device 50 for performing the method for handling 5GS location information.

In another embodiment, the controller 20 may be incorporated into the baseband processing device 12, to serve as a baseband processor.

As will be appreciated by persons skilled in the art, the circuits of the controller 20 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 is a non-transitory machine-readable storage medium which may include any combination of the following: a Universal Subscriber Identity Module (USIM), a non-volatile memory (e.g., a FLASH memory or a Non-Volatile Random Access Memory (NVRAM)), a magnetic storage device (e.g., a hard disk or a magnetic tape), and an optical disc. A USIM may contain USIM application containing functions, file structures, and elementary files, and it may be technically realized in the form of a physical card or in the form of a programmable SIM (e.g., eSIM) that is embedded directly into the UE 110. The storage device 30 may be used for storing data, including instructions and/or program code of applications, communication protocols, and/or the method for handling 5GS location information.

In particular, the storage device 30 may include a data space specific for 5GS location information. For example, if the storage device 30 includes a USIM, the data space may refer to separate Elementary Files (EFs) or a common EF in the USIM for storing 5GS location information per access. Alternatively, if the storage device 30 includes a non-volatile memory, the data space may be used to store 5GS location information per access, together with a SUbscription Permanent Identifier (SUPI) or a SUbscription Concealed Identifier (SUCI).

The display device 40 may be a Liquid-Crystal Display (LCD), a Light-Emitting Diode (LED) display, or an Electronic Paper Display (EPD), etc., for providing a display function. Alternatively, the display device 40 may further include one or more touch sensors disposed thereon or thereunder for sensing touches, contacts, or approximations of objects, such as fingers or styluses.

The I/O device 50 may include one or more buttons, a keyboard, a mouse, a touch pad, a video camera, a microphone, and/or a speaker, etc., to serve as the Man-Machine Interface (MMI) for interaction with users, such as receiving user inputs, and outputting prompts to users.

It should be understood that the components described in the embodiment of FIG. 2 are for illustrative purposes only and are not intended to limit the scope of the application. For example, the UE 110 may include more components, such as a power supply, or a Global Positioning System (GPS) device, wherein the power supply may be a mobile/replaceable battery providing power to all the other components of the UE 110, and the GPS device may provide the location information of the UE 110 for use of some location-based services or applications.

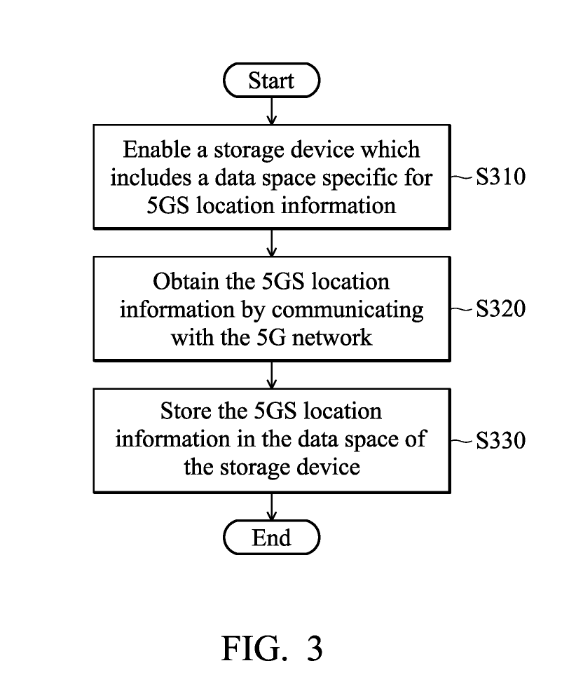

FIG. 3 is a flow chart illustrating the method for handling 5GS location information according to an embodiment of the application.

In this embodiment, the method for handling 5GS location information is executed by a UE (e.g., the UE 110) which is communicatively connected to a 5G network (e.g., NG-CNs 140/150) via 3GPP access or non-3GPP access.

To begin with, the UE enables a storage device which includes a data space specific for 5GS location information (step S310). In one embodiment, the storage device may be a USIM. In another embodiment, the storage device may be a non-volatile memory in the UE.

Next, the UE obtains the 5GS location information by communicating with the 5G network (step S320).

In one embodiment, the 5GS location information or part of it (e.g. a fresh 5G-GUTI) may be obtained during a Registration procedure, Generic UE configuration update procedure and/or Service request procedure, and reference may be made to 3GPP TS 24.501, release 15 for detailed description of these communication procedures.

Specifically, the 5GS location information may include 5GS location information for 3GPP access and 5GS location information for non-3GPP access.

The 5GS location information for 3GPP access may include at least a 5G GUTI for 3GPP access, a last visited registered TAI for 3GPP access, and a 5GS update status for 3GPP access, while the 5GS location information for non-3GPP access may include at least a 5G GUTI for non-3GPP access, a last visited registered TAI for non-3GPP access, and a 5GS update status for non-3GPP access.

Please note that the detailed description of the 5G GUTI, the last visited registered TAI, and the 5GS update status is omitted herein for brevity since it is beyond the scope of the application, and reference may be made to 3GPP TS 31.102, release 15.

Subsequently, the UE stores the 5GS location information in the data space of the storage device (step S330), and the method ends.

If the storage device is a USIM, the data space may include separate EFs for storing the 5GS location information for 3GPP access and the 5GS location information for non-3GPP access, respectively. Tables 1 and 2 below show exemplary EFs for storing the 5GS location information for 3GPP access and the 5GS location information for non-3GPP access, respectively.

TABLE 1

| | |
|---|---|
| EF_{5GS3GPPLOCI} | 5G GUTI for 3GPP access |
| | last visited registered TAI for 3GPP access |
| | 5GS update status for 3GPP access |

TABLE 2

| | |
|---|---|
| EF_{5GSN3GPPLOCI} | 5G GUTI for non-3GPP access |
| | last visited registered TAI for non-3GPP access |
| | 5GS update status for non-3GPP access |

Alternatively, the data space may include a common EF for storing both the 5GS location information for 3GPP access and the 5GS location information for non-3GPP access. Table 3 below shows an exemplary EF for storing both the 5GS location information for 3GPP access and the 5GS location information for non-3GPP access.

TABLE 3

| | |
|---|---|
| EF_{5GSLOCI} | 5G GUTI for 3GPP access |
| | last visited registered TAI for 3GPP access |
| | 5GS update status for 3GPP access |
| | 5G GUTI for non-3GPP access |
| | last visited registered TAI for non-3GPP access |
| | 5GS update status for non-3GPP access |

It should be noted that the common EF or the separate EFs for storing the 5GS location information for 3GPP access and non-3GPP access is/are new EF(s) introduced to support 5G.

If the storage device is a non-volatile memory in the UE, the 5GS location information may be stored together with the SUPI/SUCI.

Moreover, when the UE is connected in the same PLMN over both 3GPP access and non-3GPP access, some of the 5GS location information may be shared between 3GPP access and non-3GPP access. In such cases, pre-defined rules (e.g., predetermined in the 3GPP specification(s)) may be provided for the UE to identify which of the 5GS location information is common for both 3GPP access and non-3GPP access, or there may be additional information in an EF to indicate whether some of the 5GS location information is common for both 3GPP access and non-3GPP access.

In view of the forgoing embodiments, it will be appreciated that the present application realizes support of 5G in a UE, by enabling the UE to locally store the 5GS location information for both 3GPP access and non-3GPP access in a storage device, such as a USIM or a non-volatile memory. Specifically, new EF(s) and specific content of the 5GS location information are proposed and used to store the 5GS location information, so that this information may be retrieved and applied for 5G communications.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

What is claimed is:

1. A User Equipment (UE), comprising:
a wireless transceiver, configured to perform wireless transmission and reception to and from a 5G network;
a storage device, comprising a data space specific for 5G System (5GS) location information; and
a controller, configured to obtain the 5GS location information by communicating with the 5G network via the wireless transceiver, and store the 5GS location information in the data space of the storage device.

2. The UE of claim 1, wherein the storage device is a Universal Subscriber Identity Module (USIM), and the 5GS location information comprises 5GS location information for 3rd Generation Partnership Project (3GPP) access and 5GS location information for non-3GPP access.

3. The UE of claim 2, wherein the data space comprises a first Elementary File (EF) for storing the 5GS location information for 3GPP access, and a second EF for storing the 5GS location information for non-3GPP access.

4. The UE of claim 3, wherein each of the first EF and the second EF comprises information indicating whether some of the 5GS location information is common for both 3GPP access and non-3GPP access.

5. The UE of claim 2, wherein the data space comprises one EF for storing both the 5GS location information for the 3GPP access and the 5GS location information for the non-3GPP access.

6. The UE of claim 5, wherein the EF comprises information indicating whether some of the 5GS location information is common for both 3GPP access and non-3GPP access.

7. The UE of claim 2, wherein the 5GS location information for 3GPP access comprises a 5G Globally Unique Temporary Identifier (GUTI) for 3GPP access, a last visited registered Tracking Area Identity (TAI) for 3GPP access, and a 5GS update status for 3GPP access, while the 5GS location information for non-3GPP access comprises a 5G GUTI for non-3GPP access, a last visited registered TAI for non-3GPP access, and a 5GS update status for non-3GPP access.

8. The UE of claim 1, wherein the storage device is a non-volatile memory, and the controller is further configured to store a SUbscription Permanent Identifier (SUPI) or a SUbscription Concealed Identifier (SUCI) in the data space.

9. A method for handling 5GS location information, executed by a UE communicatively connected to a 5G network, the method comprising:
enabling a storage device in the UE, which comprises a data space specific for 5GS location information;
obtaining the 5GS location information by communicating with the 5G network; and
storing the 5GS location information in the data space of the storage device.

10. The method of claim 9, wherein the storage device is a USIM, and the 5GS location information comprises 5GS location information for 3GPP access and 5GS location information for non-3GPP access.

11. The method of claim 10, wherein the data space comprises a first EF for storing the 5GS location information for 3GPP access, and a second EF for storing the 5GS location information for non-3GPP access.

12. The method of claim 11, wherein each of the first EF and the second EF comprises information indicating whether some of the 5GS location information is common for both 3GPP access and non-3GPP access.

13. The method of claim 10, wherein the data space comprises one EF for storing both the 5GS location information for the 3GPP access and the 5GS location information for the non-3GPP access.

14. The method of claim 13, wherein the EF comprises information indicating whether some of the 5GS location information is common for both 3GPP access and non-3GPP access.

15. The method of claim 10, wherein the 5GS location information for 3GPP access comprises a 5G GUTI for 3GPP access, a last visited registered TAI for 3GPP access, and a 5GS update status for 3GPP access, while the 5GS location information for non-3GPP access comprises a 5G GUTI for non-3GPP access, a last visited registered TAI for non-3GPP access, and a 5GS update status for non-3GPP access.

16. The method of claim 9, wherein the storage device is a non-volatile memory, and the method further comprises:
storing an SUPI or an SUCI in the data space.
